(19) United States
(12) Patent Application Publication
(10) Pub. No.: US 2015/0120251 A1
(43) Pub. Date: Apr. 30, 2015

(54) SYSTEM FOR 3D RECONSTRUCTION OF AS-BUILT INDUSTRIAL MODEL FROM 3D DATA

(71) Applicant: Chung-Ang University Industry-Academy Cooperation Foundation, Seoul (KR)

(72) Inventor: Changwan KIM, Seoul (KR)

(21) Appl. No.: 14/313,592

(22) Filed: Jun. 24, 2014

(30) Foreign Application Priority Data
Oct. 25, 2013 (KR) 10-2013-0128089
Oct. 25, 2013 (KR) 10-2013-0128090

(51) Int. Cl. G06F 17/50; G06T 17/00

(52) U.S. Cl. CPC G06F 17/50; G06T 17/00
USPC 703/1

(57) ABSTRACT

A system for constructing a 3D industrial model from 3D data according to an embodiment of the present invention may include an object extracting unit configured to extract first to nth objects from 3D data obtained using a 3D data acquisition device, a connection relation determining unit configured to select at least one of the first to nth objects as a reference object, and selects an object satisfying a first condition with respect to the selected reference object as a connection object, and an object determining unit configured to compare information on the reference object and the connection object with data including information on actual objects so as to determine at least one of the reference object and the connection object as a specific object.

### CROSS-REFERENCE TO RELATED APPLICATION

This application claims priority to Korean Patent Application Nos. 10-2013-0128089 filed on Oct. 25, 2013, and 10-2013-0128090 filed on Oct. 25, 2013, and all the benefits accruing therefrom under 35 U.S.C. §119, the contents of which are incorporated by reference in their entirety.

### BACKGROUND

The present invention relates to a system for constructing a three-dimensional (3D) industrial model from 3D data, and more particularly, to a system for constructing a 3D industrial model by selectively extracting specific objects such as industrial facilities which exist in 3D data and using connection relations between the extracted objects.

A 3D industrial model, which is used in various fields of plant operation and maintenance such as installation and inspection of a plant and generation and update of an as-built drawing of the plant, is considered to be important.

In order to construct a 3D industrial model to which an actually built shape and location are correctly applied, a user extracts all of data corresponding to individual pipes from 3D data of a plant obtained using a 3D data acquisition device such as a laser scanner, and performs a model construction operation on the basis of the individual piping data.

According to a conventional method, when the user selects a part of data corresponding to a surface of a pipe, a region is extended to neighboring data connected to the selected data, and a cylinder is fit on the basis of the extended region. However, according to this method, the user should select a part of data corresponding to a pipe, and thus, the efficiency is decreased due to the characteristics of 3D data.

Furthermore, since pipes are complexly arranged and other facilities also exist simultaneously in the 3D data, it takes a long time and requires a high cost to extract piping data. Moreover, in order to correctly select data corresponding to a surface of a pipe which exists in complex 3D data, the user should comprehend a direction and location of the pipe in advance. However, depending on specialized knowledge and skill of the user with respect to piping, extracted piping data is changed.

Therefore, it is required to develop a technology for efficient modeling of a plant through efficient extraction of piping data.

### SUMMARY

An object of the present invention is to provide a system for constructing a 3D industrial model from 3D data by extracting information on objects from 3D data obtained using a 3D data acquisition device and efficiently determining connection relations of the objects.

Another object of the present invention is to provide a system for constructing a part or the entirety of 3D industrial model from 3D data.

According to an embodiment of the present invention, a system for constructing a 3D industrial model from 3D data includes an object extracting unit configured to extract first to nth objects from 3D data obtained using a 3D data acquisition device, a connection relation determining unit configured to select at least one of the first to nth objects as a reference object, and selects an object satisfying a first condition with respect to the selected reference object as a connection object, and an object determining unit configured to compare information on the reference object and the connection object with data including information on actual objects so as to determine at least one of the reference object and the connection object as a specific object.

The object determining unit may determine an actual object corresponding to the reference object, and determines the connection object connected to the reference object through the actual object as the specific object.

The data including information on actual objects may include connection relations of the first to nth objects.

The data including information on actual objects may include information on another object connected to at least one side end of one reference object.

The data including information on actual objects may include data included in a piping and instrument diagram (P&ID) stored in a facility database of a plant from which the 3D data is acquired.

The reference object may include a pipe.

The first condition may indicate whether a distance to the selected reference object is smaller than a preset value, wherein the preset value is changeable by a user.

The system may further include an object modeling unit configured to model at least a part of the first to nth objects by a medium of the connection object determined as the specific object by the object determining unit.

When a first reference object and a second reference object are connected to the same connection object, the object modeling unit may determine that the first reference object has a connection relation with the second reference object via the connection object.

The object extracting unit may include a data dividing unit configured to calculate normal vectors and residual values corresponding to points constituting the 3D data obtained using the 3D data acquisition device, and divide the points constituting the 3D data for each object on the basis of the normal vectors and the residual values, a neighboring point selecting unit configured to select a seed point from among points constituting each object, and select points having normal vectors of which angles with respect to a normal vector of the seed point are within a preset angle range as neighboring points, and an object classifying unit configured to calculate a curvature of an object formed by the seed point and the neighboring points, calculate a diameter of the object on the basis of the calculated curvature, and compare the diameter of the object with data including actual object classification information to determine the object as the specific object.

The number of seed points selected from among points constituting one object may be at least two, and the numbers of neighboring points corresponding to each seed point may be able to be differently set.

The preset angle may be about ±60° with respect to the normal vector of the seed point.

The system may further include a data processing unit configured to process data obtained by the 3D data acquisition device in order to extract the points constituting the 3D data from which the normal vectors and the residual values are calculated by the data dividing unit.

The data obtained by the 3D data acquisition device may include points constituting the object, and the data processing unit may process the data obtained by the 3D data acquisition device so that the number of the points constituting the 3D data from which the normal vectors and the residual values are calculated by the data dividing unit is smaller than that of the points included in the data obtained by the 3D data acquisition device.

The data including actual object classification information may include data included in a piping and instrument diagram (P&ID) stored in a facility database of a plant from which the 3D data is acquired.

The data including actual object classification information may be data in which an error range is set for data of the actual objects included in the piping and instrument diagram (P&ID).

The data dividing unit may select a first reference number of nearest neighboring points with respect to the points constituting the 3D data, determine a plane from which a vertical distance to the nearest neighboring points selected for each point is minimized as a reference plane corresponding to each plane, determine a sum of vertical distances between the reference plane corresponding to each point and the nearest neighboring points selected for each point as a residual value corresponding to each point, and determine a normal vector of the reference plane corresponding to each point as a normal vector corresponding to each point.

The data dividing unit may select a point having a minimum residual value as a seed point from among points not determined as constituting an object, select a second reference number of nearest neighboring points with respect to the selected seed point, and determine a nearest neighboring point having a normal vector that forms an angle smaller than a preset first threshold value with a normal vector of the selected seed point as a point constituting the same object as that of the selected seed point.

The data dividing unit may select a neighboring point having a residual value smaller than a preset second threshold value as a new seed point from among the neighboring points determined as points constituting the same object as that of the seed point, select the second reference number of nearest neighboring points with respect to the selected new seed point, and determine a nearest neighboring point having a normal vector that forms an angle smaller than the preset first threshold value with a normal vector of the new seed point as a point constituting the same object as that of the new seed point.

The object classifying unit may generate a curved surface formed by the seed point and the neighboring points, and calculates, from the curved surface, a curvature of an object including the curved surface.

### BRIEF DESCRIPTION OF THE DRAWINGS

Exemplary embodiments can be understood in more detail from the following description taken in conjunction with the accompanying drawings, in which:

FIG. 1 is a block diagram illustrating a system for constructing a 3D industrial model from 3D data according to an embodiment of the present invention;

FIG. 2 is a block diagram illustrating a procedure of specifying objects from 3D data for the system and method for constructing a 3D industrial model from 3D data according to the embodiment of the present invention, wherein the reference object is a pipe and other devices are connection objects;

FIG. 3 is a diagram illustrating another procedure of specifying objects from 3D data for the system and method for constructing a 3D industrial model from 3D data according to the embodiment of the present invention, wherein a connection object is a pipe and other devices are reference objects;

FIG. 4 is a block diagram illustrating the system for constructing a 3D industrial model from 3D data according to the embodiment of the present invention;

FIG. 5 is a block diagram illustrating calculated data and data including information on actual objects in the system for constructing a 3D industrial model from 3D data according to the embodiment of the present invention;

FIG. 6 is a block diagram illustrating a system for extracting a specific object from 3D data in the system for constructing a 3D industrial model from 3D data according to the embodiment of the present invention;

FIG. 7 is a diagram illustrating a plant facility for obtaining 3D data applied to the system for constructing a 3D industrial model from 3D data according to the embodiment of the present invention, and 3D data obtained for the plant facility;

FIG. 8 is a diagram illustrating a method of extracting a normal vector corresponding to one point of 3D data and a reference plane according to the normal vector, in the system for constructing a 3D industrial model from 3D data according to the embodiment of the present invention;

FIG. 9 is a flowchart illustrating a procedure of classifying a specific object after dividing data, in the system for constructing a 3D industrial model from 3D data according to the embodiment of the present invention;

FIG. 10 is a diagram illustrating objects divided through a data dividing process, in the system for constructing a 3D industrial model from 3D data according to the embodiment of the present invention;

FIG. 11 is a diagram illustrating a method for extracting a curvature of a specific object, in the system for constructing a 3D industrial model from 3D data according to the embodiment of the present invention; and

FIG. 12 is a block diagram illustrating a procedure of dividing data in the system for constructing a 3D industrial model from 3D data according to the embodiment of the present invention.

### DETAILED DESCRIPTION OF EMBODIMENTS

Hereinafter, embodiments of the present invention will be described in detail with reference to the accompanying drawings. However, the scope of the present invention is not limited to embodiments below, and those skilled in the art may easily suggest other embodiments besides the embodiments below, but the other embodiments are also construed as being in the scope of the present invention.

In the drawings, elements having the same function are referred to by the same reference numeral.

The term “industry” used herein indicates production of services as well as production of goods. That is, the term “industry” includes agriculture, forestry, fishery, construction industry, public service, transportation industry, telecommunications industry, distribution industry, financial business, insurance business, real estate business, and other service industries.

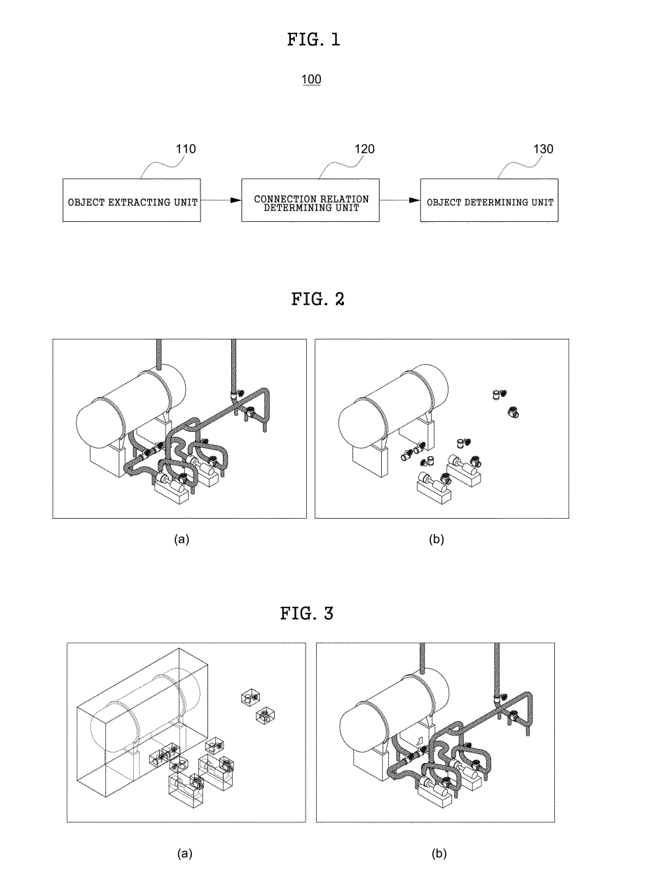

FIG. 1 is a block diagram illustrating a system for constructing a three-dimensional (3D) industrial model from 3D data according to an embodiment of the present invention.

Referring to FIG. 1, a system 100 for constructing a 3D industrial model from 3D data according to the embodiment of the present invention may include an object extracting unit 110, a connection relation determining unit 120, and an object determining unit 130.

The object extracting unit 110, which is an element for extracting first to nth objects from 3D data obtained on the basis of a 3D data acquisition device, may use 3D data obtained by processing, by a data processing unit (not illustrated), data obtained by the 3D data acquisition device such as a laser scanner.

In the case where data obtained by performing a scanning operation from various angles by the laser scanner concentrates at a specific portion, or data loss occurs due to an environmental influence, or pieces of the data obtained by the laser scanner are excessively merged at a specific portion, the data is filtered to such a degree as to obtain a result, and the filtered data is referred to as the processed 3D data.

Therefore, the number of points that constitute the 3D data processed by the data processing unit (not illustrated) may be smaller than that of points that constitute the data obtained by the 3D data acquisition device.

The system using the 3D data processed by the data processing unit (not illustrated) has a small amount of data to be processed in comparison with a system using unprocessed 3D data, thereby reducing the time and cost.

However, the data used by the object extracting unit 110 is not limited to the 3D data processed by the data processing unit (not illustrated). Therefore, the data used by the object extracting unit 110 may be the data obtained by the 3D data acquisition device before being processed by the data processing unit (not illustrated).

The first to nth objects are object names arbitrarily defined to classify the data of objects obtained by the 3D data acquisition device, wherein ‘n’ is a natural number.

The connection relation determining unit 120 may select at least one of the first to nth objects as a reference object, and may select an object that satisfies a first condition with respect to the reference object as a connection object.

The object determining unit 130 may compare information on the reference object and connection object with data including information on actual objects, so as to determine at least one of the reference object and the connection object as a specific object.

The data including information on actual objects may include information on an object connected to at least one side end of a single reference object. That is, this data may include information on a connection relation between the first to nth objects. Furthermore, this data may include data included in a piping and instrument diagram (P&ID) stored in a facility database of a plant that is a subject of 3D data acquisition.

The reference object may be a pipe or another device other than a pipe, such as a reactor or a valve.

The object extracting unit 110, the connection relation determining unit 120, and the object determining unit 130 are described in detail below.

FIG. 2 is a diagram illustrating a procedure of specifying objects from 3D data in the system for constructing a 3D industrial model from 3D data according to the embodiment of the present invention, wherein a reference object is a pipe and other devices are connection objects. FIG. 3 is a diagram illustrating another procedure of specifying objects from 3D data in the system for constructing a 3D industrial model from 3D data according to the embodiment of the present invention, wherein a connection object is a pipe and other devices are reference objects.

Referring to FIG. 2, the connection relation determining unit 120 (see FIG. 1) may select at least one of the first to nth objects extracted by the object extracting unit 110 (see FIG. 1) as a reference object, and may select an object that satisfies a first condition with respect to the reference object as a connection object.

For example, pipes in a plant facility represented by 3D data of FIG. 2A may be selected as a reference object.

The connection relation determining unit 120 selects an object that satisfies a first condition with respect to the selected reference object as a connection object. Here, as illustrated in FIG. 2B, objects other than the reference object may be connection objects. That is, devices connected to one side end or both side ends of the pipe that is the reference object may be the connection objects.

Here, the first condition indicates whether a distance from 3D data of an arbitrary object to 3D data of the selected reference object is smaller than a preset threshold value. An object having 3D data of which a distance to the 3D data of the selected reference object is smaller than the threshold value may be a connection object of the selected reference object.

For example, if the preset threshold value is 1 mm, an object having 3D data of which a distance to the 3D data of the selected reference object is not greater than 1 mm is selected as a connection object having a connection relation with the selected reference object. There may exist a plurality of connection objects having connection relations with the selected reference object. That is, objects that satisfy the first condition may be connection objects of the selected reference object regardless of the number of the objects that satisfy the first condition. The threshold value may be changed by a user.

Referring to FIG. 3, the connection relation determining unit 120 (see FIG. 1) may select at least one of the first to nth objects extracted by the object extracting unit 110 (see FIG. 1) as a reference object, and may select an object that satisfies the first condition with respect to the reference object as a connection object.

Referring to FIG. 3A, the 3D data marked by boxes represents devices and valves in the plant facility, wherein the device and the valves may be selected as reference objects.

An object that satisfies the first condition with respect to a selected reference object (one of the boxed objects) may be selected as a connection object having a connection relation with the selected reference object.

That is, the pipes of FIG. 3B may be connection objects of the selected reference objects (the devices and valves).

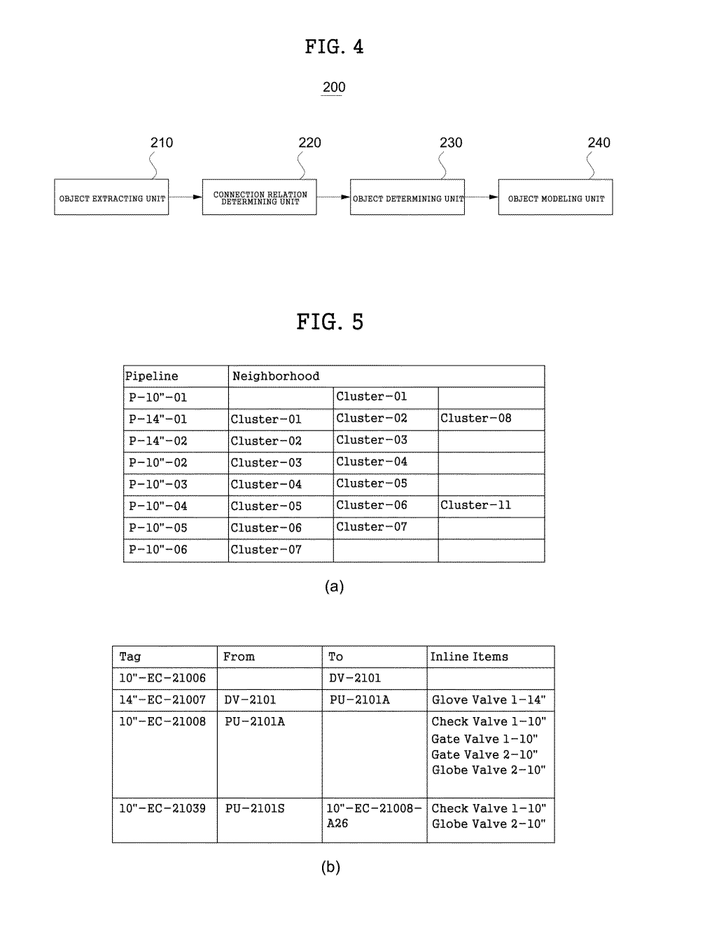

FIG. 4 is a block diagram illustrating a system for constructing a 3D industrial model from 3D data according to the embodiment of the present invention. FIG. 5 is a diagram illustrating 3D data applied to the system for constructing a 3D industrial model from 3D data according to the embodiment of the present invention and data including information on actual objects.

Referring to FIGS. 4 and 5, a system 200 for constructing a 3D industrial model from 3D data according to the embodiment of the present invention may further include an object modeling unit 240 for modeling at least a part of the first to nth objects by a medium of a reference object or a connection object determined as a specific object by an object determining unit 230.

The object modeling unit 240 may compare the data of FIG. 5A with the data of FIG. 5B so as to model objects on the basis of connection relations therebetween.

By using the object determining unit 230, information on the reference object and connection object may be compared with data including information on actual objects, so as to determine at least one of the reference object and the connection object as a specific object. A result of this operation may be recorded as data as illustrated in FIG. 5A.

That is, as illustrated in FIG. 5A, a pipeline is a specified reference object. Regarding the sign “P-10″-01”, P denotes a pipe, 10″ is a diameter of the pipe, and 01 is an arbitrarily set pipe number. The pipe (specified reference object) is the reference object specified by the object determining unit 230.

Referring to FIG. 5A, “neighborhood” is a specified connection object. Cluster-01 to Cluster-11 are specified connection objects, and the reference object of P-10″-01 has a connection relation with the object of Cluster-01. The reference object of P-14″-01 has connection relations with the objects of Cluster-01, Cluster-02 and Cluster-08. Here, it may be understood that the reference object of P-10″-01 has a connection relation with the reference object of P-14″-01 via the connection object of Cluster-01.

FIG. 5B shows data including information on actual objects.

In detail, the column of “tag” represents actual data of reference objects selected by a connection relation determining unit 220. That is, regarding the sign “10″-EC-21006”, 10″ denotes a diameter, and EC-21006 is a unique serial number of an object. The columns of “from” and “to” represent information on objects to which selected reference objects are actually connected. Objects represented by “from” and “to” may be devices such as reactors, and the column of “inline items” may represent devices such as a valve. The object of 10″-EC-21006 has a connection relation with the object of DV-2101, and the object of 14″-EC-21007 has connection relations with the objects of DV-2101, PU-210A and Glove Valve 1-14″. Furthermore, it may be understood that the object of 10″-EC-21006 has a connection relation with the object of 14″-EC-21007 via the object of DV-2101. The data including information on actual objects may be the data included in the piping and instrument diagram (P&ID) stored in the facility database of the plant.

That is, the object modeling unit 240 may model a part or the entirety of 3D data through the process of matching information extracted by the object determining unit 230 as illustrated in FIG. 5A on the basis of the data including information on actual data illustrated in FIG. 5B.

In this manner, by using the object modeling unit 240, the connection relations between the first to nth objects of 3D data may be determined, and a 3D industrial model may be constructed from 3D data obtained using the 3D data acquisition device.

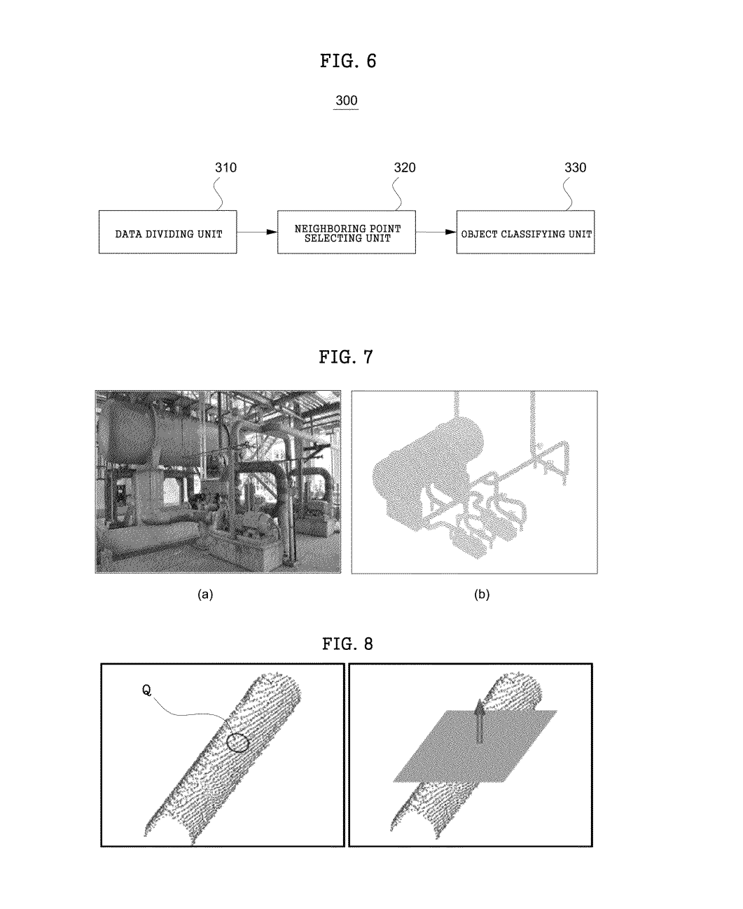

FIG. 6 is a block diagram illustrating a system for extracting a specific object from 3D data in the system for constructing a 3D industrial model from 3D data according to the embodiment of the present invention. FIG. 7 is a diagram illustrating a plant facility for obtaining 3D data applied to the system for constructing a 3D industrial model from 3D data according to the embodiment of the present invention, and 3D data obtained for the plant facility.

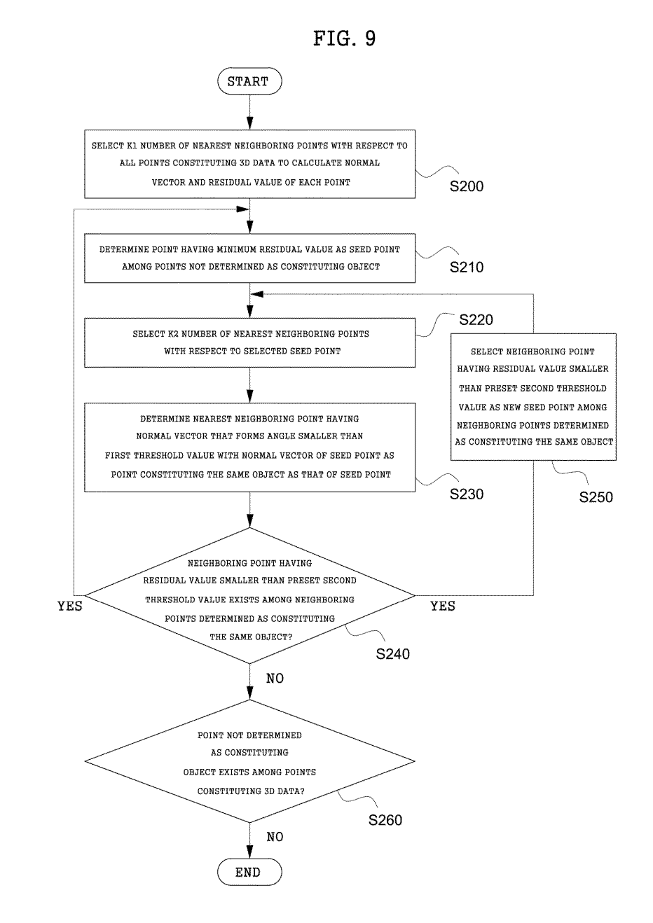

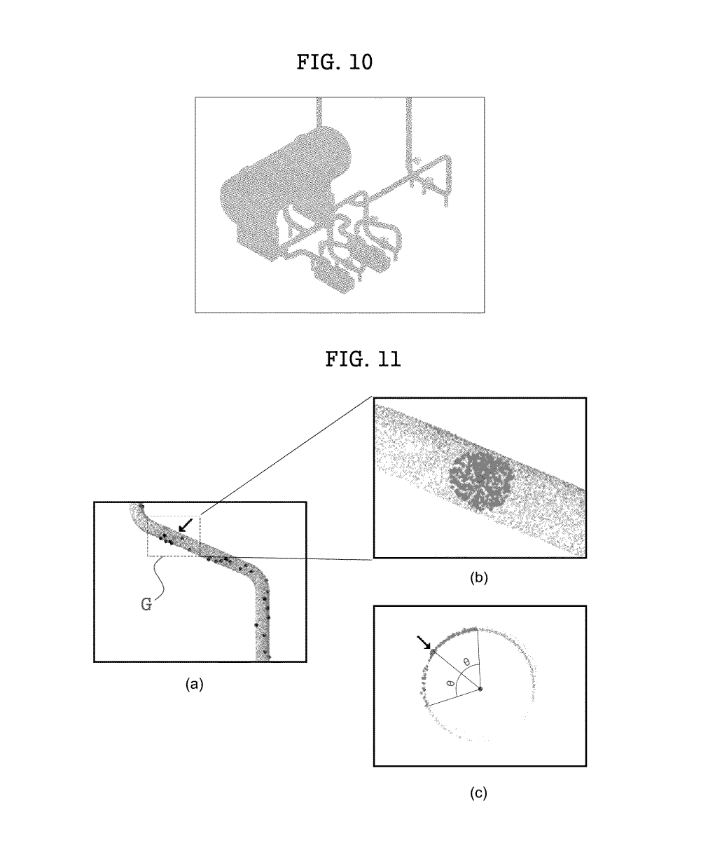

FIG. 8 is a diagram illustrating a method of extracting a normal vector corresponding to one point of 3D data and a reference plane according to the normal vector, in the system for constructing a 3D industrial model from 3D data according to the embodiment of the present invention. FIG. 9 is a flowchart illustrating a procedure of classifying a specific object after dividing data, in the system for constructing a 3D industrial model from 3D data according to the embodiment of the present invention. FIG. 10 is a diagram illustrating objects divided through a data dividing process, in the system for constructing a 3D industrial model from 3D data according to the embodiment of the present invention.

Referring to FIGS. 6 to 10, an object extracting unit 300 may include: a data dividing unit 310 that calculates normal vectors and residual values corresponding to points constituting 3D data obtained using the 3D data acquisition device, and divides the points constituting the 3D data for each object on the basis of the normal vectors and the residual values; a neighboring point selecting unit 320 that selects a seed point from among points constituting each object, and selects points having normal vectors of which angles with respect to a normal vector of the seed point are within a preset angle range as neighboring points; and an object classifying unit 330 that calculates a curvature of an object formed by the seed point and the neighboring points, calculates a diameter of the object on the basis of the calculated curvature, and then compares the diameter of the object with data including actual object classification information to determine the object as a specific object.

The object classifying unit 330 compares a diameter of an object with the data including actual object classification information so as to determine the object as a specific object. Here, the data including actual object classification information is differentiated from the data including information on actual objects to which the information on the reference object and connection object is compared by the object determining unit 130 (see FIG. 1).

In detail, the data including actual object classification information includes the number, diameters and serial numbers of pipes, and the information on actual objects includes a connection relation between a pipe and an object connected thereto, i.e., a device such as a reactor or a valve, and includes the number, dimensions and serial numbers of pipes and devices.

After the data dividing unit 310 selects a first reference number of nearest neighboring points (e.g., K₁=30) with respect to all points constituting 3D data, normal vectors and residual numbers of all points are calculated (operation S200).

Here, in order to calculate the normal vectors and residual values of the points constituting the 3D data, the data dividing unit 310 determines a target point of which a normal vector and residual value are to be calculated, from among the points constituting the 3D data, and selects K₁ number of neighboring points nearest to the determined target point using the k-nearest neighbors algorithm.

The k-nearest neighbors algorithm is used to find K₁ number of data nearest to reference data. When the K₁ number of neighboring points nearest to the target point are selected, the data dividing unit 310 determines a plane from which a vertical distance to the selected neighboring points is minimized as a reference plane (see FIG. 8).

Next, the data dividing unit 310 determines a normal vector of the reference plane as a normal vector of the target point, and calculates a sum of vertical distances between the K₁ number of neighboring points as a residual value.

FIG. 8 illustrates a point Q selected from among some points constituting the 3D data as described above, a reference plane corresponding to the point Q, and a normal vector of the reference plane.

In this manner, the data dividing unit 310 may calculate the normal vector of the target point and the residual value. The above-mentioned procedure is performed on all the points constituting the 3D data. Here, a smaller residual value represents a shorter distance between a plane and points, and thus, a curved surface formed by the target point and neighboring points approximates to a plane.

Here, all the points constituting the 3D data may be 3D data processed by the data processing unit (not illustrated), or may be data primarily obtained by the 3D data acquisition device, i.e., unprocessed data.

In the case where data obtained by performing a scanning operation from various angles by the laser scanner concentrates at a specific portion, or data loss occurs due to an environmental influence, or pieces of the data obtained by the laser scanner are excessively merged at a specific portion, the data is filtered to such a degree as to obtain a result, and the filtered data is referred to as processed 3D data.

Therefore, the number of points that constitute the 3D data processed by the data processing unit (not illustrated) may be smaller than that of points that constitute the data obtained by the 3D data acquisition device.

The system using the 3D data processed by the data processing unit (not illustrated) has a small amount of data to be processed in comparison with a system using unprocessed 3D data, thereby reducing the time and cost.

The data dividing unit 310 selects a seed point having a minimum residual value from among points not determined as constituting an object (operation S210). When a seed point is initially selected after normal vectors and residual values are calculated with respect to all the data constituting the 3D data, all the points have not yet been determined as constituting an object, and thus, a point having a minimum residual value is selected as the seed point from among all the points constituting the 3D data. Thereafter, the data dividing unit 310 selects a second reference number of nearest neighboring points, i.e., K₂ (e.g., 30) number of nearest neighboring points (operation S220).

Here, the nearest neighboring points are selected using the above-mentioned k-nearest neighbors algorithm, and the second reference number may be experimentally determined as described above with respect to the first reference number.

Next, the data dividing unit 310 determines a nearest neighboring point of which a normal vector forms an angle smaller than a preset first threshold value (e.g., 30°) with a normal vector of the seed point, as a point that constitutes the same object as that of the seed point (operation S230). This is expressed as an equation as below.

∥nₚ·nₛ∥>cos(θₜₕ) (1)

where, nₚ denotes a normal vector of a seed point, nₛ denotes a normal vector of each nearest neighboring point, and θₜₕ denotes a first threshold value

The first threshold value is based on statistical data for determining a nearest neighboring point and a seed point as points that constitute the same object, and thus may be changed by a user.

Next, the data dividing unit 310 determines whether there exists a neighboring point having a residual value smaller than a preset second threshold value from among the neighboring points determined as constituting the same object as that of the seed point (operation S240).

Here, the second threshold value is determined as 5 that corresponds to top 5% from the smallest to the largest of residual values of all points.

For example, in the case where the 3D data is formed by 100 points and the points have different values ranging from 1 to 100, the second threshold value is determined as 5 that is a residual value corresponding to the top 5% from the smallest to the largest.

The second threshold value may be changed by a user.

If there exists a neighboring point having a residual value smaller than the preset second threshold value from among the neighboring points determined as constituting the same object as that of the seed point, the data dividing unit 310 selects the neighboring point as a new seed point (S250), and repeatedly performs operations S220 to S250 until a new seed point is not selected any more.

Here, the fact that a new seed point is not selected any more represents that there doesn't exist a point that constitutes the same object as that of the initially selected seed point. On the contrary, if it is determined that there doesn't exist a neighboring point having a residual value smaller than the preset second threshold value from among the neighboring points determined as constituting the same object as that of the seed point, the data dividing unit 310 checks whether there exists a point that has not been determined as constituting an object among the points constituting the 3D data (operation S260).

If there exists a point that has not been determined as constituting an object among the points constituting the 3D data, the data dividing unit 310 determines that data division for all the points constituting the 3D data is completed and finishes a data division process.

As described above, the data dividing unit 310 performs a process for dividing the points constituting the 3D data for each object unit. FIG. 10 illustrates each object divided by the data dividing unit 310, wherein the objects may different colors so as to be easily distinguished. As illustrated in FIG. 10, the 3D data is divided into regions of similar planes or data of which a normal vector is not excessively changed.

Here, plant data used for an experiment may be formed by 100,000 points expressed by 3D coordinate values, and may be data obtained by matching 3D data obtained from multiple locations.

Furthermore, the 100,000 points may be 3D data processed by the data processing unit, or may be data primarily obtained by the 3D data acquisition device, i.e., unprocessed data.

FIG. 11 is a diagram illustrating a method for extracting a curvature of a specific object, in the system for constructing a 3D industrial model from 3D data according to the embodiment of the present invention.

The neighboring point selecting unit 320 (see FIG. 6) will be described with reference to FIG. 11. The neighboring point selecting unit 320 selects K₃ (e.g., 30) number of seed points from among points constituting each object divided by the data dividing unit 310 (see FIG. 6), selects points having normal vectors that form angles within a preset angle range with a normal vector of the selected seed point as neighboring points, and then generates a curved surface formed by the selected neighboring points.

The neighboring point selecting unit 320 is described in more detail with reference to FIG. 11 as below.

(a) K₃ number of arbitrary points (seed points) are selected from points constituting a specific object (the black points of (a) of FIG. 11 are seed points).

(b) Magnifying the G portion, points having normal vectors that form angles within a preset angle range (±θ) with normal vectors of the seed points selected in (a) are selected as neighboring points. The number of the neighboring points having normal vectors that form angles within the preset angle range with normal vectors of the seed points may be two or more, and the numbers of neighboring points corresponding to each seed point may be the same or different. That is, points located around a seed point within a preset angle range are neighboring points, and the number thereof is determined according to how many points exist within the range (neighboring points are selected around the central seed point of (b) of FIG. 11).

(c) The seed point and neighboring points distributed therearound of (b) of FIG. 11 are viewed from a different angle. The points having normal vectors that form angles of ±θ with a normal vector of the seed point are selected as neighboring point (the arrow of (c) of FIG. 11 indicates the seed point).

Here, ±θ is a minimum angle for calculating a diameter of a specific object formed by a seed point and neighboring points using the method described below. Here, ±θ may be preferably about ±60°, but is not limited thereto.

That is, θ may be changed according to an error range preset by a user.

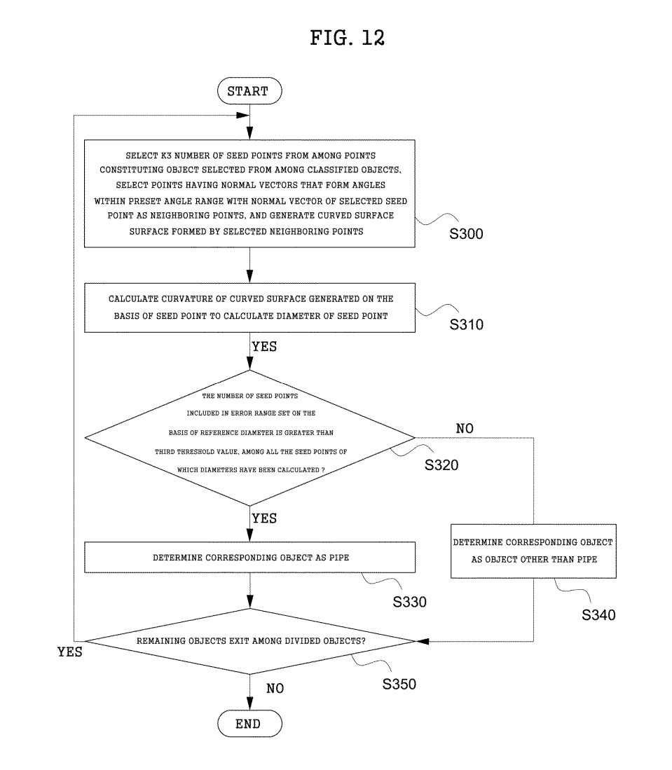

FIG. 12 is a block diagram illustrating a procedure of dividing data in the system for constructing a 3D industrial model from 3D data according to the embodiment of the present invention.

Referring to FIG. 12, the neighboring point selecting unit 320 (see FIG. 6) selects seed points and neighboring points, and generates a curved surface formed by the seed points and the neighboring points (operation S300).

Here, those skilled in the art could understand a method of generating the curved surface formed by the seed points and the neighboring points thereof. Therefore, detailed descriptions of the method are omitted.

The object classifying unit 330 (see FIG. 6) calculates a curvature of a curved surface generated for one of the determined seed points so as to calculate a diameter of the seed point (operation S310).

Here, the curvature of the curved surface is a maximum value between the maximum value and a minimum value calculated for the curved surface. This is for calculating a diameter of a pipe of each divided object, on the assumption that a curvature in a direction of a cross section of a pipe has a maximum value. Furthermore, a diameter corresponding to a seed point may be calculated by obtaining a reciprocal number of the curvature.

Next, the data dividing unit 330 determines whether the number of seed points included in an error range (e.g., 10%) set on the basis of a reference diameter is greater than a third threshold value (e.g., 24), among all the seed points of which diameters have been calculated (operation S320). Here, the reference diameter is a diameter of a pipe used in a plant from which 3D data has been acquired. That is, the reference diameter represents data including actual object classification information.

This is expressed as an equation as below.

$$0.9 {r}_{st} \leq \frac{1}{{k}_{i}} \leq 1.1 {r}_{st} \qquad ( 2 )$$

where, rₛₜ denotes a diameter of a pipe used in a pipe from which 3D data has been acquired, i.e., a diameter included in data including actual object classification information, and kᵢ denotes a curvature (i=1-30) corresponding to each determined seed point.

If the number of seed points within the error range is greater than the third threshold value as a result of applying Equation (2), the object classifying unit 330 determines the corresponding object as a specific object having the reference diameter (operation S330).

Therefore, in the case where 30 seed points are determined with respect to an object so as to classify the object, if the number of seed points having diameters that fall into the set error range, i.e., 10%, the object classifying unit 330 classifies the object as the specific object having the reference diameter (the set error range and the number of seed points may be changed by a user).

For example, in the case where the data including actual object classification information contains information on pipes having a diameter of 10 inches and information on pipes having other diameters, if diameters of an object calculated by the object classifying unit 330 include 13 diameters of not less than 9 inches and less than 10 inches, 12 diameters of not less than 10 inches and less than 11 inches, 3 diameters of greater than 11 inches, and 2 diameters of less than 9 inches, this object corresponds to a 10-inch pipe.

On the contrary, if the number of seed points within the error range is smaller than the third threshold value, the object classifying unit 330 determines the object as an object other than a pipe (operation S340).

The third threshold value may be changed by a user.

If classification of selected objects is completed, the object classifying unit 330 determines whether unclassified remaining objects exist among divided objects (operation S350).

If the remaining objects exist, the object classifying unit 330 selects one of the remaining objects and repeatedly performs operations S300 to S350.

The present invention may be implemented in the form of computer-readable codes in a computer-readable recording medium. The computer-readable recording medium includes any type of a recording device for storing data readably by a computer system. The computer-readable recording medium includes, for example, a ROM, a RAM, a CD-ROM, a magnetic tape, a floppy disk, and an optical data storage device, and may also be implemented in the form of a carrier wave (for example, transmission via the Internet). Furthermore, the computer-readable recording medium may be distributed to computer systems connected to a network so that computer-readable codes may be stored and executed in a distribution manner.

According to the system for constructing a 3D industrial model from 3D data according to the present invention, data corresponding to pipes, reactors, valves and the like may be rapidly and correctly extracted from 3D data obtained by a 3D data acquisition device without actual measurement or observation in a plant field, and thus, the labor and time for constructing a 3D industrial model may be reduced.

Furthermore, by using a piping and instrument diagram (P&ID) in which characteristics of pipes used in a plant are recorded, information on pipes, reactors, valves and the like may be correctly extracted from 3D plant data, and thus, a correct 3D piping model may be constructed.

Moreover, the 3D data obtained by the 3D data acquisition device may be processed so that a user may easily use the data and the time and cost for extracting a specific object from the 3D data may be reduced.

Although the present invention has been described with reference to the specific embodiments, it is not limited thereto. Therefore, it will be readily understood by those skilled in the art that various modifications and changes can be made thereto without departing from the spirit and scope of the present invention defined by the appended claims.

What is claimed is:

1. A system for constructing a 3D industrial model from 3D data, comprising:
an object extracting unit configured to extract first to nth objects from 3D data obtained using a 3D data acquisition device;
a connection relation determining unit configured to select at least one of the first to nth objects as a reference object, and selects an object satisfying a first condition with respect to the selected reference object as a connection object; and
an object determining unit configured to compare information on the reference object and the connection object with data comprising information on actual objects so as to determine at least one of the reference object and the connection object as a specific object.

2. The system of claim 1, wherein the object determining unit determines an actual object corresponding to the reference object on the basis of the data including information of the actual objects, and determines the connection object connected to the reference object through the actual object as the specific object.

3. The system of claim 1, wherein the data comprising information on actual objects comprises connection relations of the first to nth objects.

4. The system of claim 3, wherein the data comprising information on actual objects comprises information on another object connected to at least one side end of one reference object.

5. The system of claim 3, wherein the data comprising information on actual objects comprises data included in a piping and instrument diagram (P&ID) stored in a facility database of a plant from which the 3D data is acquired.

6. The system of claim 1, wherein the reference object comprises a pipe.

7. The system of claim 1, wherein the first condition indicates whether a distance to the selected reference object is smaller than a preset value, wherein the preset value is changeable by a user.

8. The system of claim 1, further comprising an object modeling unit configured to model at least a part of the first to nth objects by a medium of the connection object determined as the specific object by the object determining unit.

9. The system of claim 8, wherein, when a first reference object and a second reference object are connected to the same connection object, the object modeling unit determines that the first reference object has a connection relation with the second reference object via the connection object.

10. The system of claim 1, wherein the object extracting unit comprises:
a data dividing unit configured to calculate normal vectors and residual values corresponding to points constituting the 3D data obtained using the 3D data acquisition device, and divide the points constituting the 3D data for each object on the basis of the normal vectors and the residual values;
a neighboring point selecting unit configured to select a seed point from among points constituting each object, and select points having normal vectors of which angles with respect to a normal vector of the seed point are within a preset angle range as neighboring points; and
an object classifying unit configured to calculate a curvature of an object formed by the seed point and the neighboring points, calculate a diameter of the object on the basis of the calculated curvature, and compare the diameter of the object with data including actual object classification information to determine the object as the specific object.

11. The system of claim 10, wherein the number of seed points selected from among points constituting one object is at least two, and the numbers of neighboring points corresponding to each seed point are able to be differently set.

12. The system of claim 10, wherein the preset angle is about ±60° with respect to the normal vector of the seed point.

13. The system of claim 10, further comprising a data processing unit configured to process data obtained by the 3D data acquisition device in order to extract the points constituting the 3D data from which the normal vectors and the residual values are calculated by the data dividing unit.

14. The system of claim 13, wherein the data obtained by the 3D data acquisition device comprises points constituting the object, and the data processing unit processes the data obtained by the 3D data acquisition device so that the number of the points constituting the 3D data from which the normal vectors and the residual values are calculated by the data dividing unit is smaller than that of the points included in the data obtained by the 3D data acquisition device.

15. The system of claim 10, wherein the data comprising actual object classification information comprises data included in a piping and instrument diagram (P&ID) stored in a facility database of a plant from which the 3D data is acquired.

16. The system of claim 15, wherein the data comprising actual object classification information is data in which an error range is set for data of the actual objects included in the piping and instrument diagram (P&ID).

17. The system of claim 10, wherein the data dividing unit
selects a first reference number of nearest neighboring points with respect to the points constituting the 3D data, determines a plane from which a vertical distance to the nearest neighboring points selected for each point is minimized as a reference plane corresponding to each plane,
determines a sum of vertical distances between the reference plane corresponding to each point and the nearest neighboring points selected for each point as a residual value corresponding to each point, and
determines a normal vector of the reference plane corresponding to each point as a normal vector corresponding to each point.

18. The system of claim 17, wherein the data dividing unit selects a point having a minimum residual value as a seed point from among points not determined as constituting an object, selects a second reference number of nearest neighboring points with respect to the selected seed point, and determines a nearest neighboring point having a normal vector that forms an angle smaller than a preset first threshold value with a normal vector of the selected seed point as a point constituting the same object as that of the selected seed point.

19. The system of claim 18, wherein the data dividing unit selects a neighboring point having a residual value smaller than a preset second threshold value as a new seed point from among the neighboring points determined as points constituting the same object as that of the seed point, selects the second reference number of nearest neighboring points with respect to the selected new seed point, and determines a nearest neighboring point having a normal vector that forms an angle smaller than the preset first threshold value with a normal vector of the new seed point as a point constituting the same object as that of the new seed point.

20. The system of claim 10, wherein the object classifying unit generates a curved surface formed by the seed point and the neighboring points, and calculates, from the curved surface, a curvature of an object comprising the curved surface.
